(19) United States
(12) Patent Application Publication
(10) Pub. No.: US 2012/0014647 A1
(43) Pub. Date: Jan. 19, 2012

(54) Optical Receiver Module

(75) Inventors: Shinya Kanke, Kawaguchi-shi (JP); Shimpei Morioka, Kawaguchi-shi (JP)

(73) Assignee: Enplas Corporation, Kawaguchi-shi (JP)

(21) Appl. No.: 13/183,218

(22) Filed: Jul. 14, 2011

(30) Foreign Application Priority Data
Jul. 16, 2010 (JP) 2010-161760

(51) Int. Cl. G02B 6/32

(52) U.S. Cl. 385/33

(57) ABSTRACT

An optical receiver module 1 includes : a sleeve that holds an optical fiber; an optical flat surface provided in the sleeve and into which light emitted from the optical fiber enters; a lens provided in the sleeve that converges and emits the light that has entered the optical flat surface; and a light-receiving element that receives the light emitted from the lens and converts optical Signals to electrical signals. The optical flat surface is formed such as to be tilted by 20° to 40° or 60° to 70° in relation to a light-receiving surface of the light-receiving element.

### TECHNICAL FIELD

The present invention relates to an optical receiver module used in optical communication.

### BACKGROUND ART

An optical receiver module typically includes a sleeve that holds an optical fiber, a lens that converges light emitted from the optical fiber, and a light-receiving element that receives the light emitted from the optical fiber. The light emitted from the optical fiber held in the sleeve enters the light-receiving element through the lens. The light-receiving element then converts optical signals corresponding to the light to electrical signals.

In a convention optical receiver module, a portion of the light emitted from the optical fiber is reflected by a light-emitting end surface of the sleeve, a light-receiving surface of the light-receiving element, and the like before entering the light-receiving element and returns. In some instances, the reflected returning light enters the optical fiber. The reflected returning light may cause noise in optical communication.

In recent years, in optical communication, advancements have been made in extending distance and increasing capacity, and noise reduction in optical receiver modules is being strongly demanded. Therefore, since the past, various measured have been taken to suppress the amount of reflected returning light entering the optical fiber.

For example, Patent Literature 1 discloses a technology in which the light-emitting end surface (optical flat surface) of the sleeve is tilted within a range of 4° to 12° in relation to the light-receiving surface of the light-receiving element, thereby changing the direction of the reflected returning light and reducing noise. In addition, Patent Literature 2 discloses a technology in which the light-receiving element is disposed such as to be shifted from a center axis of the optical receiver module, thereby suppressing the amount of reflected returning light. Furthermore, Patent Literature 3 discloses a technology in which the light-receiving surface of the light-receiving element is processed such as to be tilted in relation to an optical axis, thereby suppressing the amount of reflected returning light.
Patent Literature 1: Japanese Patent Laid-open Publication No. 2006-98763
Patent Literature 2: Japanese Patent Laid-open Publication No. 2005-148452
Patent Literature 3: Japanese Patent Laid-open Publication No. Heisei 05-152599

### DISCLOSURE OF INVENTION

### Problem to be Solved by the Invention

Here, when the lens in the optical receiver module expands or contracts due to temperature change, refractive index also changes, and the position of a light converging point changes.

However, in the conventional technologies, the change in position of the light converging point due to temperature change is not taken into consideration. For example, when a tilt angle of the light-emitting surface of the sleeve in relation to the light-receiving surface of the light-receiving element is within a range of 4° to 12° as in Patent Literature 1, an amount of change in convergence distance in relation to temperature change increases. Therefore, in Patent Literature 1, even when centering is performed to set the light-receiving surface of the light-receiving element in a position with maximum coupling efficiency at normal temperature (such as 20° C.), the position of the light converging point is shifted in an optical axis direction as a result of subsequent temperature change. Therefore, optical performance (particularly coupling efficiency) deteriorates. Thus, in Patent Literature 1, centering of the light-receiving element in the optical axis direction is required to be highly accurate to achieve a predetermined reception quality even when the temperature has changed, thereby causing increased cost and reduced yield rate.

The present invention has been achieved in light of the above-described issues. An object of the present invention is to provide an optical receiver module capable of suppressing an amount of reflected returning light entering an optical fiber and capable of preventing deterioration of optical performance due to temperature change at low cost and with a high yield rate.

### Means for Solving Problem

An optical receiver module of the present invention includes a sleeve that holds an optical fiber; an optical flat surface provided in the sleeve and into which light emitted from the optical fiber enters; a lens provided in the sleeve that converges and emits the light that has entered the optical flat surface; and a light-receiving element that receives the light emitted from the lens and converts optical signals to electrical signals. The optical flat surface is formed such as to be tilted by 20° to 40° or 60° to 70° in relation to a light-receiving surface of the light-receiving element.

### Effect of the Invention

According to the present invention, the amount of reflected returning light entering an optical fiber can be suppressed, the amount of change in the position of a light converging point in relation to temperature change can be reduced, and the amount of changes in performance due to variations during manufacture can be reduced. As a result, the accuracy required when centering the light-receiving element in the optical axis direction can be reduced, thereby preventing deterioration in optical performance due to temperature change at low cost and with a high yield rate.

### BRIEF DESCRIPTION OF DRAWINGS

FIG. 1 is a cross-sectional view of an optical receiver module according to an embodiment of the present invention.

FIG. 2 is a diagram of a relationship between an angle of an optical flat surface and an amount of change in light converging point in the optical receiver module according to the embodiment of the present invention.

### EXPLANATIONS OF LETTERS OR NUMERALS

### Best Mode(s) for Carrying out the Invention

An embodiment of the present invention will hereinafter be described in detail with reference to the drawings.

[Configuration of Optical Receiver Module]

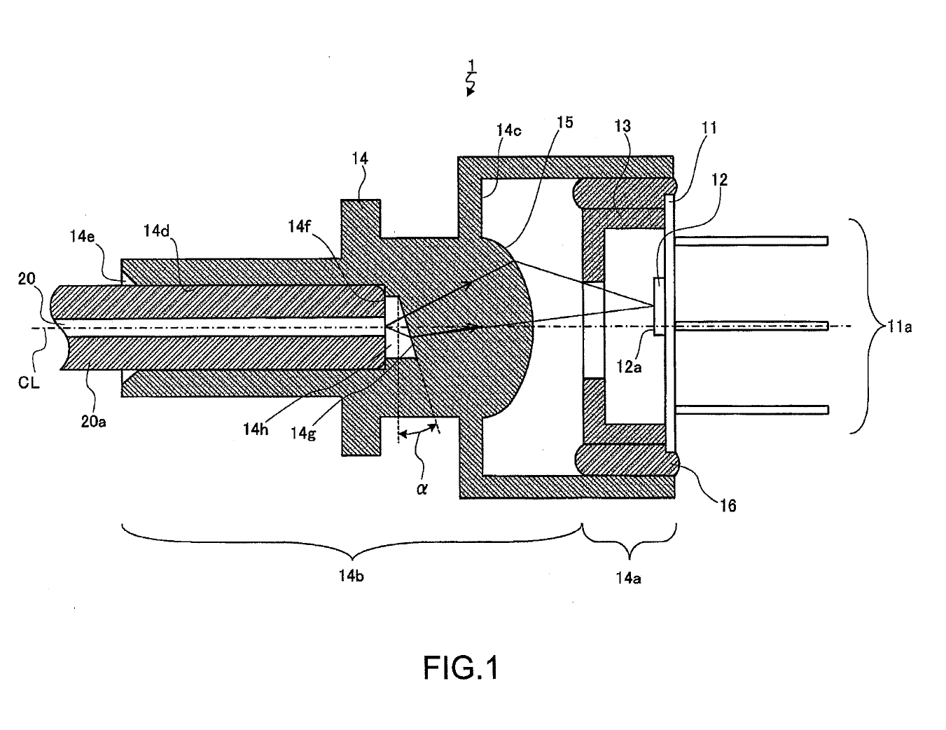

FIG. 1 is a cross-sectional view of an optical receiver module according to the embodiment of the present invention. An optical receiver module 1 is mainly composed of a stem 11, a light-receiving element 12, a cover glass 13, a sleeve 14, and a lens 15. An optical fiber cable having an optical fiber 20 is attached to the optical receiver module 1 such as to be attached and detached freely. An axial line CL in FIG. 1 is a center axis of the optical fiber 20 and a center line (optical axis) of light emitted from the optical fiber 20.

The stem 11 is composed of metal and has a circular cylindrical shape. A terminal 11a for connecting to an external device is sealed and fixed to the stem 11 without coming into electrical contact. The light-receiving element 12 and an amplifying integrated circuit (IC) (not shown) are mounted on the stem 11.

The light-receiving element 12 is a semiconductor element such as a photodiode (PD) that receives light emitted from the optical fiber 20 and converts optical signals to electrical signals. A light-receiving surface 12a of the light-receiving element 12 is perpendicular to the axial line CL. The amplifying

IC is electrically connected to the light-receiving element 12 and amplifies the electrical signal from the light-receiving element 12. The terminal 11a is electrically connected to the amplifying IC, and transmits the electrical signals amplified by the amplifying IC to the external device.

In addition, the cover glass 13 is provided on the stem 11 such as to cover the light-receiving element 12. The cover glass 12 is composed of a glass material having light transmittance, and transmits light emitted from the optical fiber 12 and converged by the lens 15. The stem 11 and the cover glass 14 are hermetically sealed together, and the space formed between the stem 11 and the cover glass 13 is filled with inert gas such as nitrogen.

In addition, the stem 11 and the cover glass 14 are fixed to the sleeve 14 by an adhesive 16. The sleeve 14 is formed by injection-molding a resin material having light transmittance, such as polyetherimide (PEI), polycarbonate (PC), or poly (methyl methacrylate) (PMMA). The sleeve 14 has a simple shape and, therefore, can be easily formed by injection molding.

The sleeve is composed of a large diameter section 14a having a large outer diameter on the light-receiving element 12 side, and a small diameter section 14b having a small outer diameter on the optical fiber 20 side.

The large diameter section 14a has a circular ring shape that is open on one end and covers the cover glass 13. The convex lens 15 is formed in the center section of a bottom surface 14c of the open hole in the large diameter section 14a. The lens 15 converges the light emitted from the optical fiber 20.

An optical fiber insertion hole 14d is provided in the small diameter section 14b to attach the optical fiber 20 and a ferrule 20a. The optical fiber insertion hole 14d is a hole that is open on one end and has an inner diameter that is almost the same as the outer diameter of the ferrule 20a. The center line of the optical fiber insertion hole 14d and the optical axis of the lens 15 match the axial line CL. On the opened end of the optical fiber insertion hole 14d, a taper 14e is provided to smoothly guide the ferrule 20a.

A bottom surface 14f of the optical fiber insertion hole 14d is formed into a flat surface that is parallel with the light-receiving surface 12a of the light-receiving element 12. The center section of the bottom surface 14f is provided with a recess section 14h having a smaller inside diameter than the optical fiber insertion hole 14d to form an optical flat surface 14g.

The optical flat surface 14g is a surface through which the light emitted from the optical fiber 20 enters and is formed tilted in relation to the light-receiving surface 12a of the light-receiving element 12. As a result, the direction of reflected returning light can be changed, thereby suppressing the amount of reflected returning light entering the optical fiber 20 and reducing noise. A suitable value for a tilt angle α of the optical flat surface 14g in relation to the light-receiving surface 12a of the light-receiving element 12 will be described hereafter.

The optical fiber 20 transmits optical signals. The tip end portion of the optical fiber 20 is stored in the ferrule 20a. The ferrule 20a has a circular cylindrical shape with a through hole in the center. The tip end portion of the optical fiber 20 is placed within the through hole.

The optical fiber cable including the optical fiber 20 is attached to the sleeve 14 such as to be attached and detached freely, in a state in which the tip end of the ferrule 20a is in contact with the bottom surface 14f of the optical fiber insertion hole 14d.

In the optical receiver module 1 configured as described above, the light emitted from the end surface of the optical fiber 20 passes through an air layer in the recess section 14h, and enters the sleeve 14 from the optical flat surface 14g. The light is then emitted such as to be converged by the lens 15, passes through the cover glass 13, and is optically coupled to the light-receiving surface 12a of the light-receiving element 12.

[Suitable Angle Range for Optical Flat Surface]

Next, a suitable range of the tilt angle α will be described based on a relationship between the tilt angle α of the optical flat surface 14g and the amount of change in the light converging point due to temperature change.

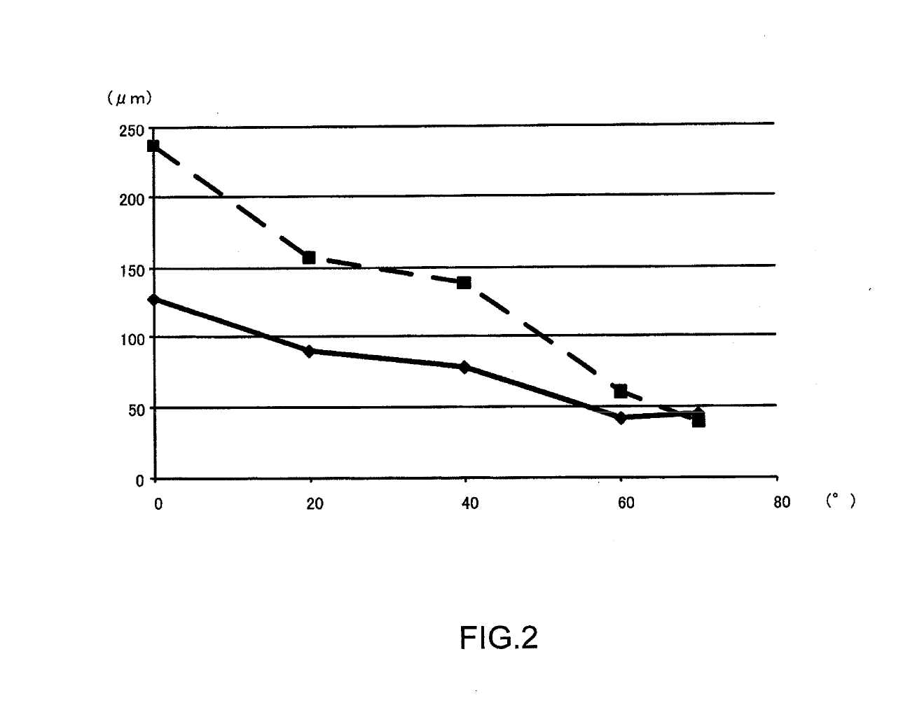

FIG. 2 is a diagram of the relationship between the tilt angle α of the optical flat surface 14g and the amount of change in the position of the light converging point due to temperature change. In FIG. 2, the horizontal axis indicates the tilt angle α (°) of the optical flat surface 14g, and the vertical axis indicates the amount of change (μm) in the position of the light converging point when the temperature is changed from −40° C. to 85° C. FIG. 2 shows the results of simulation performed using a single-mode fiber and light having a wavelength of 1550 μm. The solid line graph shown in FIG. 2 indicates the simulation results of when the lens 15 is formed having low power. The broken line graph shown in FIG. 2 indicates the simulation results of when the lens is formed having high power.

As FIG. 2 clearly shows, the amount of change in the light converging point decreases as the tilt angle α increases. In the tilt angle α range of 20° to 40° and 60° to 70°, the gradient of the graph is more gradual than in other ranges.

In the range in which the gradient of the graph is gradual, the amount of changes in performance as a result of variations in the angle of the optical flat surface 14g during manufacture of the optical receiver module 1 is reduced.

Therefore, a suitable range of the tilt angle α is from 20° to 40° and from 60° to 70°.

Here, when the tilt angle α increases, coupling efficiency decreases. Therefore, when high coupling efficiency (such as 70% or more) is required, the tilt angle α is preferably 20° to 40°. Even when the tilt angle is 60° to 70°, coupling efficiency of 60% or more can be achieved. Therefore, if no issues arise in terms of practical use, the tilt angle of 60° to 70° can be used.

When the tilt angle is greater than 70°, the optical flat surface 14g is required to be enlarged to enable all light emitted from the optical fiber 20 to enter the optical flat surface 14g. The space between the optical flat surface 14g and the surface of the lens 15 becomes thin, possibly adversely affecting the flow of resin during molding. Therefore, in terms of practical use, the tilt angle α is preferably set to 70° or less.

[Effects According to the Embodiment]

As described above, according to the present embodiment, the optical flat surface 14g is tilted by 20° to 40° or by 60° to 70° in relation to the light-receiving surface 12a of the light-receiving element 12. As a result, the direction of the reflected returning light can be changed, and the amount of reflected returning light entering the optical fiber can be suppressed. In addition, the amount of change in the light converging point in relation to temperature change can be reduced, and the amount of changes in performance due to variations during manufacture can be reduced. As a result, the accuracy required when centering the light-receiving element in the optical axis direction can be reduced, thereby preventing deterioration in optical performance due to temperature change at low cost and with a high yield rate.

In Patent Literature 1, the tilt angle of the optical flat surface in relation to the light-receiving element is 4° to 12°. A first reason for this is that, when the tilt angle is less than 4°, the reflected returning light enters the optical fiber and noise occurs. A second reason for this is that, when the tilt angle is greater than 12°, the position of the light converging point on a flat surface perpendicular to the optical axis shifts significantly from the optical axis as a result of refraction of the light on the optical flat surface.

However, the position of the light-receiving element in the direction perpendicular to the optical axis can be easily adjusted during manufacture of the optical receiver module. In addition, the position of the light converging point on the flat surface perpendicular to the optical axis changes minimally even when the temperature changes. Therefore, even when the tilt angle in the direction perpendicular to the optical axis is set to be greater than 12°, a desired reception quality can be achieved by centering to the position with maximum coupling efficiency.

According to the above-described embodiment, an instance is described in which measurements are taken using a single-mode fiber and light having a wavelength of 1550 μm. However, the present invention is not limited thereto. Similar effects can be achieved when light having other wavelengths is used. The present invention can also be applied to a multi-mode fiber.

1. An optical receiver module comprising:
a sleeve that holds an optical fiber;
an optical flat surface provided in the sleeve and into which light emitted from the optical fiber enters;
a lens provided in the sleeve that converges and emits the light that has entered the optical flat surface; and
a light-receiving element that receives the light emitted from the lens and converts optical signals to electrical signals, wherein
the optical flat surface is formed such as to be tilted by 20° to 40° or 60° to 70° in relation to a light-receiving surface of the light-receiving element.
